(19) United States
(12) Patent Application Publication
(10) Pub. No.: US 2006/0149713 A1
(43) Pub. Date: Jul. 6, 2006

(54) System, method, and computer program product for improving accuracy of cache-based searches

(75) Inventor: Alan Walker, Southlake, TX (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Sabre Inc.

(21) Appl. No.: 11/030,494

(22) Filed: Jan. 6, 2005

(51) Int. Cl. G06F 17/30

(52) U.S. Cl. 707/3

(57) ABSTRACT

A system, method, and computer program product search a cache database in response to a search request from a user, determine which of the search results is most likely to be preferred by the user, and verify the preferred results against a real-time database. If the verification determines that the preferred results are accurate, then all the search results are provided to the user. If the verification determines that the preferred results are not accurate, then those results are deleted and the remaining results are provided to the user. As a result, the accuracy of the results returned to the user is increased, while queries of the real-time database are utilized only where most useful and are thereby reduced.

### FIELD OF THE INVENTION

The present invention relates generally to systems, methods, and computer program products for searching electronically stored data, and more particularly, to systems, methods, and computer program products for searching data that is cached and data that is more recent.

### BACKGROUND OF THE INVENTION

In a database system, large amounts of data are stored in a computerized database. The database is typically stored on one or more servers, accessible over a network by various authorized users. The authorized users may access the database to simply search for information, or the users may also enter information in the database.

The main database in a database system may be extremely large in some circumstances. There may be a large number of authorized users, who may each conduct extensive searches of the main database. As the size of the main database, the number of authorized users, and the extent of the searches grow, problems can result. Due to limited bandwidth on the network, the communications over the network may slow during times of peak activity. Additionally, the server hosting the main database may not be able to handle the increased activity, resulting in delayed responses to search requests by users. Also, the main database may contain such vast amounts of data that conducting even simple searches of the data is very time consuming.

One solution to the above problem is to use cached data. Using cached data involves copying some or all of the data in the main database (called the real-time data) into a separate cache database. The use of cached data may improve the problem in different ways depending upon how the cache database is implemented. The cache database may be hosted on a server physically located near the users of the data, which would eliminate the need to communicate over an external network and would thereby increase the speed of access to the data. The cache database may only have a subset of the data that exists in the main database, which would allow for faster searches because less data is being searched. There may also be more than one cache database for a given main database. Having multiple cache databases allows for searches from multiple users to be evenly distributed over the multiple cache databases, thereby ensuring that no single database has to handle all the searches.

Despite the several advantages of using cached data, there are disadvantages. The main disadvantage of using cached data is that the cached data may be stale, or no longer accurate. In a database system utilizing cached data, the data may be cached (i.e. copied from the main database into the cache database) on a periodic basis, depending on the frequency of activity in the main database. For example, the data may be cached once a week, once a day, or once an hour. Regardless of how often the data is cached, as time elapses from when the data is cached the likelihood increases that the cached data is no longer identical to the data stored in the main database. This means that a user may receive data from the cache database, in response to a search, that is no longer accurate because the real-time data has changed since the data was cached.

One example of a database system that utilizes cached data is an air travel planning system. In an air travel planning system, for example, a large number of users search for available flights which satisfy each user's travel requirements. A user may input the desired origin and destination airports, the dates and times of the desired departure and return, and possibly one or more preferred airlines. To retrieve information on available flights satisfying the user's requirements, a large number of searches of the available flight data must be conducted. After searching the available flight data, typically several flight options are displayed to the user. These flight options typically have different prices, different departure and arrival times, different airlines, and may be non-stop, may involve one or more stops, or may require connecting to another flight to reach the final destination. The user then may choose to purchase any of the flight options displayed, or may choose to run another, different search. In choosing to purchase a ticket for a particular flight, the user may choose the lowest price flight option if price is the most important factor. Alternatively, the user may choose the flight option that arrives closest to the desired time, even if it is more expensive, if convenience is the most important factor to that user. There are many factors to consider and many reasons why a particular user may choose a particular flight. A user may choose not to purchase any of the flight options displayed, also for a variety of reasons.

In a typical air travel planning system, there are a number of main databases containing real-time flight data. These main databases are typically the databases of each airline. The airline databases contain real-time availability for every flight that particular airline offers. For example, Alpha Airlines' flight # 886 from Charlotte to Boston on Oct. 30, 2004, may have twenty seats available in Y fare class (unrestricted) and no seats available in F fare class (first class) as of Oct. 27, 2004. Alpha Airlines' database would contain this real-time availability information, as well as availability for all fare classes, for all Alpha Airlines flights. The airlines send flight availability information from their real-time databases to databases belonging to a number of Global Distribution Systems (GDSs). The various GDSs, such as Sabre, Amadeus, Galileo, and WorldSpan, act as middlemen to sell airline tickets through various customer channels, such as travel agencies and the Internet. This availability information is sent to the GDSs on a periodic basis, thus the GDS databases can be considered cache databases. It should be appreciated that other entities within an air travel planning system may use cache databases. For example, travel planning websites, such as Travelocity, Expedia, and Orbitz, will typically use cache databases. Additionally, websites run by airlines to sell tickets directly to consumers may also use cache databases.

A GDS typically builds its cache database by storing or caching the responses it receives from the airlines in response to real-time queries of the airline databases. When a GDS directly queries an airline database, this may be called Direct Connect Availability (DCA) queries. These DCA queries of the airline database may be in response to a user's search request, or may be performed proactively to populate the cache database. By caching the data it receives in response to real-time queries, the GDS builds the cache database such that some of the flight availability information is available without performing DCA queries.

Due to size limitations of the GDS databases, the GDSs do not typically request availability information for all flights on all airlines. That much information would likely be too large for the GDS databases to handle. Because of this, the GDSs will typically request, and therefore the GDS databases will typically contain, only availability data for those flights that have been recently searched by GDS users. For example, a GDS may only request availability data for those flights which have been searched by its users in the past thirty days.

The availability data in the GDS database typically has an expiration date. This expiration date is the date after which the data should not be used because it has a higher likelihood of being stale and therefore incorrect. The expiration date of any particular piece of availability data may be based on a variety of factors, such as when the data was cached, the time of day of the flight, the day of the week of the flight, how far into the future the flight is scheduled, whether it is a connecting or direct flight, and the number of seats showing as available. In one approach, only data which is expired will be updated from the airline databases. It should be appreciated that, in this context, expired does not have the same meaning as stale. Expired data has a higher likelihood of being incorrect (i.e., stale), but it is not necessarily incorrect. Stale data is, by definition, incorrect. Expired data may or may not be stale, and stale data may or may not be expired. Typically, the goal of the GDS would be to set the expiration dates for data early enough to prevent the data from getting stale yet late enough to minimize the size and frequency of the data requests to the airlines.

Because the results of prior DCA queries are typically stored in the cache database, a user search request may or may not trigger a DCA query. If the flight availability data that satisfies the user's request is stored in the cache database and it is not expired, the GDS would typically use provide the cached data to the user. This cached data is not always accurate, even when it is not expired. By querying an airline database via DCA, therefore, the GDS can ensure that it will return up-to-date (and therefore accurate) availability information in response to a user's search request. A DCA query may be used when a user has requested a search for which availability data for a particular flight is required, but the availability data for that particular flight is expired and has not yet been updated. Additionally, a DCA query may be required where availability data is required for a flight which has not been recently searched and which is therefore not in the GDS database.

When the availability data in a GDS cache becomes stale, two types of errors can result when a user searches for available flights. The first type of error occurs when the user is told that a particular flight is available when it is actually not available. This may occur because the seats that were available when the cache data was sent to the GDS have since been sold, and new cache data reflecting the current unavailability of that flight has not yet been sent to the GDS. When a user attempts to purchase a ticket on a flight in this situation, the GDS then attempts to secure the ticket from the airline for the user. If the flight is not available, the GDS receives an error response message, called a UC (i.e., unconfirmed) error, from the airline. The user would then be notified that the flight is not actually available. This type of error is likely to frustrate the user, and reduce user confidence in the GDS. This type of error may also be referred to as a Type I error.

The second type of error that can occur when GDS cache data becomes stale occurs when the GDS data shows that a particular flight is not available when it actually is available. This may occur because the airline has made available more seats in a particular class of seats since the data was cached. Therefore, a class of seats that had been sold out when the cache data was sent to the GDS has now become available, and new cache data reflecting the current availability of that class of seat on that flight has not yet been sent to the GDS. In this type of error, the flight choice will not be presented to the user as an option even if it would have satisfied the search request so the user does not see this type of error. However, the GDS and the airline may have lost an opportunity to sell a ticket for that flight, especially if that flight would have been desirable to the user in terms of price or timing. This type of error may also be referred to as a Type II error.

In theory, the most accurate information would be provided to GDS users if all flight availability data was obtained using DCA queries to get real-time information from the airlines for every user search request. However, all of the searches for all of the users cannot be conducted on the DCA directly because network bandwidth and server limitations would cause a great deal of delay in the searches. This would cause an unacceptable delay for the user to see the search results. Additionally, some airlines charge a fee to the GDS for every query of the airline database and therefore querying DCA every time for every search might be prohibitively expensive.

There is, therefore, is a tradeoff between using cached data, which allows fast searching and lower costs but increases the risk of error, and using real-time queries, which reduce errors but may slow searches and increase costs. As such, there is a need for a system, method and computer program product for improving the accuracy of searches of cached data by using a combination of cached data and real-time queries to maximize accuracy while minimizing search delays and cost.

### BRIEF SUMMARY OF THE INVENTION

A system, method and computer program product are therefore provided that search a cache database in response to a search request from a user, determine which of the options returned by the search is likely to be selected by the user and thereafter search another database containing at least some data that is more current than the cached data to determine the accuracy of the option that has been determined to be likely to be selected. As a result, the accuracy of the results returned to the user is increased relative to conventional techniques that search only the cache database, while queries of another database containing more current data, such as a real-time database, are utilized only where most useful so as to conserve processing time and resources otherwise expended in querying a real-time database.

In one embodiment, a method of conducting a search is provided that initially searches cached data and returns a plurality of options that satisfy a search request. The plurality of options that are returned are then analyzed to determine which of those options are likely to be selected. In one embodiment, for example, the plurality of options that are returned may be analyzed with a discrete choice model of historic preferences from a plurality of searches. In this regard, the discrete choice model may be selected from a group consisting of multinomial, logit, nested logit, generalized extreme value, probit, hybrid logit and latent class. Once the options that are likely to be selected have been determined, a search of another database that contains at least some data that is more current than the cached data may be conducted to determine the accuracy of at least one of the options that is likely to be selected. In this regard, the other database may be searched to determine the accuracy of at least the option that has been determined to be most likely to be selected.

By conducting a hybrid search of both cached data and more current data, the method of this embodiment of the present invention can balance the competing concerns of the accuracy and reliability of the search results with issues relating to timeliness and search costs. In this regard, the initial search of cached data can be performed relatively quickly and at a relatively low cost. Thereafter, one or more of the options that are returned from the search of the cached data may be further evaluated by considering more current data from another database to improve the accuracy of the results eventually provided to the user. While the search of the other, more current database increases the time and, in some instances, costs associated with the overall search, the additional time and costs are moderated by only conducting additional searches those options returned by the search of the cached data that are determined to be likely to be selected.

In one embodiment, the search of the other, more current database may only be performed in some instances depending upon the recency with which the cached data has been updated. In this embodiment, for example, the cached data may initially be searched and the options returned from the search of the cached data may be analyzed to determine which of the options are likely to be selected. For those options that are likely to be selected, it may be determined if the relevant cached data is expired and, if so, search another database containing more current data in order to determine the accuracy of those options that were based upon cached data that has expired. In this embodiment, the time and expense required for the search of the other database may be avoided in instances in which the cached data has not expired and is therefore generally more reliable.

In addition to the method for conducting a search described above, other aspects of the present invention are directed to corresponding systems and computer program products for conducting an improved search. The method, system and computer program product of the present invention may conduct searches of various types of data. For example, the cache data and the data stored by the other database may include availability data, such as airline flight availability data in one advantageous application.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a flowchart of the operation of improving the accuracy of cache-based searches, according to one embodiment of the present invention; and

FIG. 2 is a schematic block diagram of a system for improving the accuracy of cache-based searches, according to one embodiment of the present invention.

### DETAILED DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

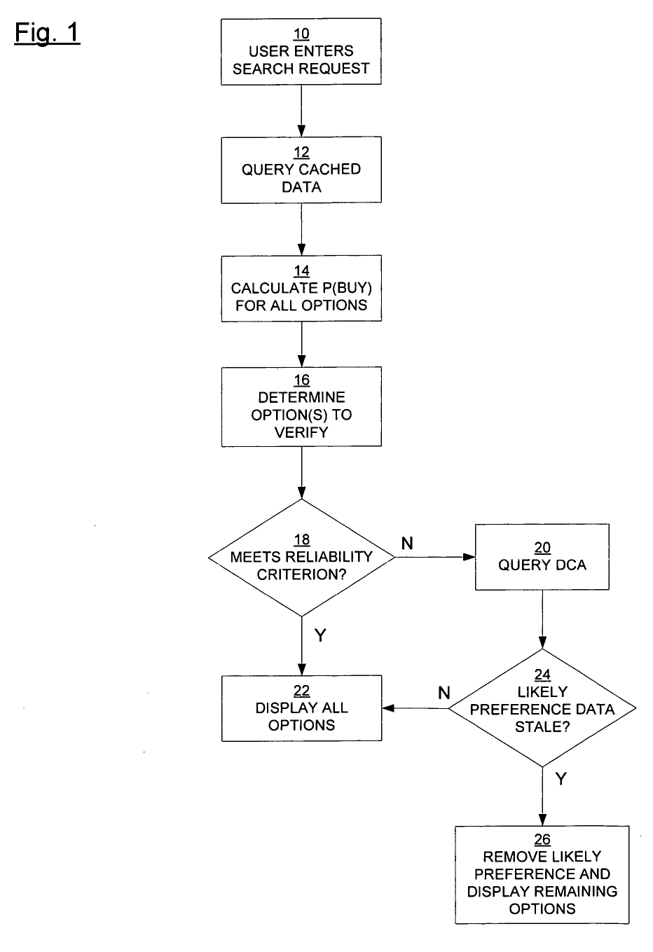

FIG. 1 is a flowchart of the operations performed by a method for improving the accuracy of cache-based searches, according to one embodiment of the present invention. While embodiments of the present invention will be described in terms of an air travel planning system for purposes of explanation, it should be appreciated that the present invention may be used in any type of travel planning system, in any type of availability checking system, in any type of purchasing system, or in any system utilizing cached and real-time databases.

As shown in step 10 of FIG. 1, a user enters a search request. In regards to an air travel planning system, the search request will typically include several parameters defining the specifics of the flight the user wishes to purchase, such as a desired origin and destination cities and departure and return dates. For example, the user may enter Charlotte as the origin city and Boston as the destination city, and November 24 as the departure date and November 29 as the return date. While most user searches in an air travel planning system involve round-trip travel, the present invention will be described in terms of one-way travel. It should be appreciated that, however, that the system, method, and computer program product of the present invention may be used for searches involving round-trip travel.

In step 12, a cache database is queried in response to the request. In an air travel planning system, for example, the GDS system queries its cache database to search for flights that might satisfy the user's request. As discussed above, the cache database contains cached data that had been downloaded from the airline databases. The GDS typically makes several queries of the cache database to identify a number of flight options to present to the user. As a result of the query, a number of flight options are identified that might satisfy the user's request.

For example, in response to the above user search request, the GDS may identify the following three flight options: (1) Alpha Airlines flight number 123, a non-stop flight with a price of $493; (2) Beta Airlines flight number 456, a flight with one stop in Philadelphia and a price of $614; and (3) Gamma Airlines flight number 789, a non-stop flight with a price of $703. It should be appreciated that a typical air travel planning system would identify a larger number of flights that satisfy the user's search request than the three flights illustrated here, and the system, method, and computer program product of the present invention may be used with a larger number of flight options.

Once the GDS has searched the cache database and identified a number of flight options that might satisfy the user's request, the next step is to calculate the likelihood for each flight option that a user might purchase that flight option, as shown in step 14. This likelihood is expressed as a percentage and termed P(buy). In one embodiment, P(buy) is calculated using a discrete choice model of the historic preferences of a plurality of searchers. In one more particular embodiment of the invention, P(buy) is calculated using a multinomial choice model. In other embodiments, the discrete choice model may be logit, nested logit, generalized extreme value, probit, hybrid logit, latent class, or any other appropriate discrete choice model, or any other probability model known to those skilled in the art. In an illustrative example, however, P(buy), for each flight option i, may be calculated using the following logit choice model:

$$P ( {buy}_{i} ) \frac{{ⅇ}^{- {u}_{i}}}{{\sum }_{j = 1}^{n} {ⅇ}^{- {u}_{i}}} where {u}_{j} = {\sum }_{k = 1}^{m} {β}_{jk} {x}_{jk} .$$

In this model, u represents the utility value of flight option i,j represents all flight options, β represents the utility coefficient, k indexes the vector of flight option service characteristics (such as price, non-stop or connecting flight, time of day, airplane type, and airline), and xⱼₖ represents the specific service characteristic of flight option i and flight option service characteristic k. This list of service characteristics is illustrative and not intended to limit the scope of the invention. Other service characteristics could be analyzed to calculate P(buy). The utility coefficient is determined using logistic regression, as known to those skilled in the art.

In one embodiment of the invention, if P(buy) is added up for every flight option the sum would be one, such that the likelihood that none of the options will be selected is, by default, zero and therefore need not be determined. In other embodiments, the discrete choice model may be used to also determine the likelihood that none of the options will be selected.

After P(buy) has been calculated for all flight options, the next step would typically be to determine which flight option or options should be verified using DCA, as shown in step 16. Verifying the flight option the user is likely to prefer using DCA has the effect of decreasing the overall likelihood of getting a UC error from an airline when a user attempts to purchase a ticket. For example, if the overall rate of stale (i.e., incorrect) data in the cache database is 5% (this is termed P(not avail)), then the likelihood of a UC error for any group of flight options is 5% if only the cache data used. However, for any option which is verified using DCA, the likelihood of a UC error if that option is selected becomes zero. Reducing the likelihood of the most likely to be chosen option reduces the overall likelihood of a UC error. This is illustrated in table 1 below:

TABLE 1

| Option | Price | P(buy) | Data Source | P(not avail) | P(UC) |
|---|---|---|---|---|---|
| 1 | $493 | 70% | DCA | 0% | 0% |
| 2 | $614 | 20% | Cache | 5% | 1% |
| 3 | $703 | 10% | Cache | 5% | 0.5% |

The likelihood of a UC error (termed P(UC)) for each option is calculated by multiplying P(buy) times P(not avail) for each. In this example, option 1 with a P(buy) value of 70% would likely be the option verified using DCA. Therefore, since P(not avail) for option 1 would now be zero, this reduces the P(UC) for option 1 to zero. P(UC) can be calculated for options 2 and 3 which have not been verified and which therefore still have a P(not avail) of 5%. This results in P(UC) for option 2 of 1% and P(UC) for option 3 of 0.5%. The P(UC) value for each option can be summed to calculate the total P(UC). Total P(UC) is an expression of the overall likelihood of getting a UC error given the available flight options. In this example, the total P(UC) is 1.5%. Therefore, by verifying one option using DCA, the total P(UC) was reduced from 5% to 1.5%.

It should be appreciated that if option 1 was not verified by using DCA, the P(UC) for option 1 would be 3.5% (i.e., 70% times 5%), and the total P(UC) for this group of options would be 5% (i.e., 3.5% plus 1% plus 0.5%). It should also be appreciated that the 5% P(not avail) figure above is for illustrative purposes only. P(not avail) for cached data may vary depending upon a number of factors. Regardless of the P(not avail) value of the particular cache database, the system, method, and computer program product of the present invention are capable of reducing the total P(UC) value and thereby increasing user confidence in the results returned in response to their query.

There are several possible methods to perform step 16. One possible method would be to verify the option (or options if there is a tie) with the highest P(buy) value. Another possible method would be to verify every option with a P(buy) value above a predefined value, for example 25%. Another possible method would involve monitoring the amount of user searches being conducted. During times of high user activity, only the option with the highest P(buy) value might be verified, whereas during times of low user activity a greater number of options may be verified.

Another possible method to perform step 16 would be to verify as many flight options as necessary to reduce the total P(UC) to below a predefined value, for example 1.5%. Table 2 illustrates four flight options, with only the option having the highest P(buy) value (i.e., option 1) being verified using DCA. The total P(UC) in this example would be 2% (i.e., 0% plus 1% plus 0.5% plus 0.5%). In order to reduce the total P(UC) to below 1.5% at least one additional flight option would need to be verified.

TABLE 2

| Option | P(buy) | Data Source | P(not avail) | P(UC) |
|---|---|---|---|---|
| 1 | 60% | DCA | 0% | 0% |
| 2 | 20% | cache | 5% | 1% |
| 3 | 10% | cache | 5% | 0.5% |
| 4 | 10% | cache | 5% | 0.5% |

Table 3 illustrates the same four flight options, but in this example the two options with the highes P(buy) values (i.e., option 1 and option 2) are verified against DCA. As illustrated in Table 3, this reduces the total P(UC) to 1%. As this is below 1.5%, no additional flight options would need to be verified in this method.

TABLE 3

| Option | P(buy) | Data Source | P(not avail) | P(UC) |
|---|---|---|---|---|
| 1 | 60% | DCA | 0% | 0% |
| 2 | 20% | DCA | 0% | 0% |
| 3 | 10% | Cache | 5% | 0.5% |
| 4 | 10% | Cache | 5% | 0.5% |

After determining which of the flight option(s) to verify using one of the methods described above or any other appropriate method, it may be desirable to immediately proceed with verifying the flight option(s) using DCA as shown in step 20. In this regard, at least one flight option would be verified against DCA for each user search request. Alternatively, it may be desirable to determine if the cache data for the option(s) to be verified meets a predefined reliability criterion, as shown in step 18. One example of a reliability criterion may be the recency of the cached data for the option(s) to be verified. Data that have been recently downloaded from the airline databases to the cache database would likely still be accurate. In such a situation it might be possible to presume the data will be accurate and not verify any options. Therefore, step 18 would determine if the cache data for the option(s) to be verified is recent enough to presume accuracy. What is considered recent enough to be able to presume accuracy will likely vary from one embodiment to another. For example, in one embodiment, data that was downloaded from an airline database within ten minutes of the user query may be considered recent enough. Another example of a reliability criterion may be the number of seats shown as available in the cached data for the option(s) to be verified. A flight option which appears in the cached data to have a large number of seats available may be presumed to be available even if the data is not recent, because it may be unlikely that such a large number of seats were sold since the data was cached. For example, in one embodiment, a flight option that appears in the cached data to have more than nine seats available may be considered to have a large number of seats available and need not be verified. It should be appreciated that these two examples of reliability criteria are for illustrative purposes only. Other reliability criteria, or combinations of criteria, could be used. It should also be appreciated that step 18 could be performed earlier in this process. For example, in one embodiment step 18 could be performed before step 14, in which case steps 14 and 16 would likely only be performed if the data was determined to not be recent.

In addition to step 18, it should be appreciated that there are other steps, not illustrated in FIG. 1, that might be taken to reduce the number of flight options that are verified using DCA. For example, if the departure and/or return date of the user's search request is far in the future it may be desirable to presume the flight is available and not verify any options. Additionally, if the cache data shows a large number of seats available for a particular flight option, it may be desirable to presume that there will still be some seats available even though the cache data is not recent.

If it is determined in step 18 that the cache data for the likely user preference(s) is recent enough to presume accuracy, then all of the flight options are displayed to the user without querying DCA, as shown in step 22. If however, it is determined in step 18 that the cache data for the likely user preference(s) is not recent enough to presume accuracy, then DCA is queried to verify the availability as shown in step 20. If the DCA query shows that the cache data is stale and the likely user preference(s) is/are not available, then the option(s) that is stale is deleted and the remaining options are displayed to the user as shown in step 26. If the DCA query verifies that the likely user preference(s) is/are available, then all of the flight options are displayed to the user, as shown in step 22. It should be appreciated that, any time DCA is queried, the availability data received as a result of the DCA query may be entered into the cache database, such that this updated availability data is available for future searches.

In one embodiment of the invention not illustrated in FIG. 1, the recency or expiration of the cached data is not considered. In such an embodiment, a probabilistic model is used to predict the accuracy of the cached data, and the search of the other, more current database may only be performed in those instances where the stochastic process model predicts that the cached data is not accurate. This probabilistic model may be stochastic process model, such as a compound Poisson model, or any other suitable model.

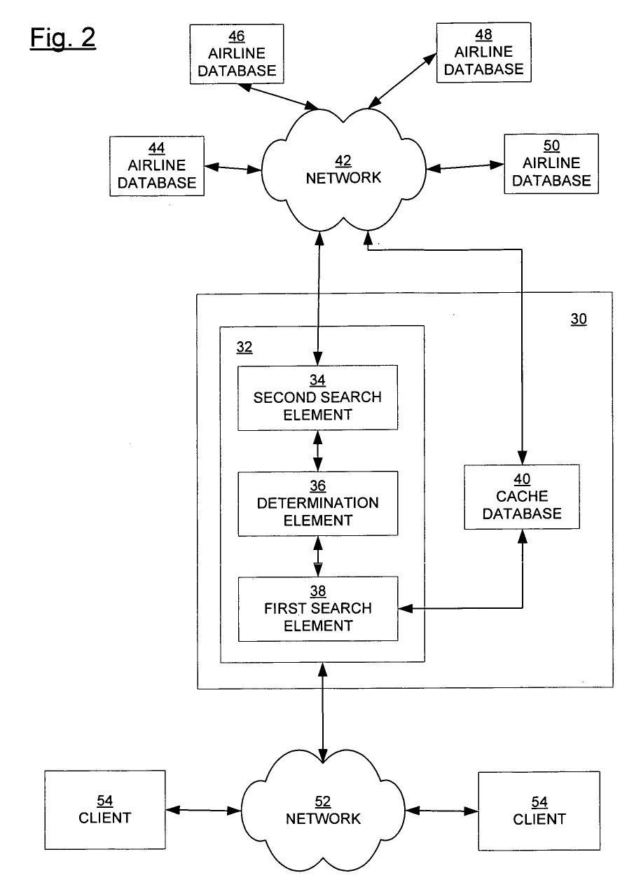

FIG. 2 is a schematic block diagram of a system for improving the accuracy of cache-based searches, according to one embodiment of the present invention. FIG. 2 illustrates a system using a client/server configuration. In the exemplary system of FIG. 2, a Global Distribution Service (GDS) 30 comprises a processing element 32 and a cache database 40. The processing element 32 comprises a first search element 38, a determination element 36, and a second search element 34. The GDS 30 is in communication over a network 42 with a number of airline databases 44, 46, 48 and 50. The GDS 30 is also in communication over a network 52 with a number of users or clients 54. Network 34 and network 52 may be any type of network, such as the Internet or a proprietary network.

Client 54 may enter a search request for a flight on the GDS 30 over network 52. In response to the search request, the first search element 38 of the processing element 32 typically searches the cache database 40 to identify flight options that may satisfy the client's search request. As noted before, the cache database 40 is periodically populated with flight availability data from the airline databases 44, 46, 48, and 50 over network 42. After the first search element 38 has identified flight options that may satisfy the client's search request, the determination element 36 typically calculates P(buy) for each flight option. Then the determination element 36 typically determines which of the flight options to verify using DCA. This may be done using one of the methods discussed above, or any appropriate method.

After determining which flight options should be verified, the determination element 36 may determine whether the cache data for the flight options to be verified is recent. If the data is recent, the processing element will typically return all the identified flight options over network 52 to the client that entered the search request. If the data for some of the flight options is not recent, the availability data for those options may be verified using DCA. In this embodiment, verifying the data may be done by the second search element 34 querying the appropriate airline database (44, 46, 48, or 50) over network 42. If the second search element 34 determines that the cache data for any flight option was stale and that flight is not available, then that flight option will be deleted and the remaining flight options will be returned over network 52 to the client that entered the search request. If the second search element 34 determines that the cache data for all verified flight options was accurate and all the flight options are available, then all identified flight options will typically be returned over network 52 to the client that entered the search request.

While FIG. 2 illustrates a system of the present invention using a client/server configuration, it should be appreciated that the client/server configuration is shown for example purposes only and that they system of the present invention could utilize configurations other than client/server. It should also be appreciated that the overall system architecture shown in FIG. 2 is for example purposes only, and not intended to limit the scope of the present invention. The system of the present invention could be implemented using a number of different system configurations.

The method of improving accuracy of cache-based searches may be embodied by a computer program product. The computer program product includes a computer-readable storage medium, such as the non-volatile storage medium, and computer-readable program code portions, such as a series of computer instructions, embodied in the computer-readable storage medium. Typically, the computer program is stored by a memory device and executed by an associated processing unit, such as the processing element of the server.

In this regard, FIG. 1 is a flowchart of methods and program products according to the invention. It will be understood that each step of the flowchart, and combinations of steps in the flowchart, can be implemented by computer program instructions. These computer program instructions may be loaded onto a computer or other programmable apparatus to produce a machine, such that the instructions which execute on the computer or other programmable apparatus create means for implementing the functions specified in the flowchart step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the flowchart step(s).

Accordingly, steps of the flowchart support combinations of means for performing the specified functions, combinations of steps for performing the specified functions and program instruction means for performing the specified functions. It will also be understood that each step of the flowchart, and combinations of steps in the flowchart, can be implemented by special purpose hardware-based computer systems which perform the specified functions or steps, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method of conducting a search in response to a search request comprising:
searching cached data and returning a plurality of options that satisfy the search request;
determining which of the plurality of options that are returned are likely to be selected; and
searching another database containing at least some data that is more current than the cached data to determine accuracy of at least one of the options that are likely to be selected.

2. The method of claim 1 wherein determining which of the plurality of options are likely to be selected comprises analyzing the plurality of options with a discrete choice model of historic preferences from a plurality of searches.

3. The method of claim 2 wherein the discrete choice model is selected from the group consisting of multinomial choice, logit, nested logit, generalized extreme value, probit, hybrid logit, and latent class.

4. The method of claim 1 wherein searching another database comprises searching another database to determine accuracy of the one option most likely to be selected.

5. The method of claim 1, wherein the cached data and data stored by the other database comprise availability data.

6. The method of claim 5, wherein the availability data is chosen from the group comprising airline flight availability and hotel room availability.

7. A method of conducting a search in response to a search request comprising:
searching cached data and returning a plurality of options that satisfy the search request;
determining which of the plurality of options that are returned are likely to be selected;
determining if the cached data for at least one of the options that are likely to be selected is expired; and
searching another database containing at least some data that is more current than the cached data to determine accuracy of at least one of the options that are likely to be selected if the cached data meets a predefined reliability criterion.

8. The method of claim 7 wherein determining which of the plurality of options are likely to be selected comprises analyzing the plurality of options with a discrete choice model of historic preferences from a plurality of searches.

9. The method of claim 8 wherein the discrete choice model is selected from the group consisting of multinomial choice, logit, nested logit, generalized extreme value, probit, hybrid logit, and latent class.

10. The method of claim 7 wherein the predefined reliability criterion is unexpired.

11. A system for conducting a search in response to a search request comprising:
a first search element for searching cached data and returning a plurality of options that satisfy the search request;
a determination element for determining which of the plurality of options that are returned are likely to be selected; and
a second search element for searching another database containing at least some data that is more current than the cached data to determine accuracy of at least one of the options that are likely to be selected.

12. The system of claim 11 wherein the determination element determines which of the plurality of options are likely to be selected by analyzing the plurality of options with a discrete choice model of historic preferences from a plurality of searches.

13. The system of claim 12 wherein the discrete choice model is selected from the group consisting of multinomial choice, logit, nested logit, generalized extreme value, probit, hybrid logit, and latent class.

14. The system of claim 11 wherein the second search element searches another database to determine accuracy of the one option most likely to be selected.

15. The system of claim 11, wherein the cached data and data stored by the other database comprise availability data.

16. The system of claim 15, wherein the availability data is chosen from the group comprising airline flight availability and hotel room availability.

17. A system for conducting a search in response to a search request comprising:
a first search element for searching cached data and returning a plurality of options that satisfy the search request;
a determination element for determining which of the plurality of options that are returned are likely to be selected and for determining if the cached data for at least one of the options that are likely to be selected is expired; and
a second search element for searching another database containing at least some data that is more current than the cached data to determine accuracy of at least one of the options that are likely to be selected if the cached data meets a predefined reliability criterion.

18. The system of claim 17 wherein the determination element determines which of the plurality of options are likely to be selected by analyzing the plurality of options with a discrete choice model of historic preferences from a plurality of searches.

19. The system of claim 18 wherein the discrete choice model is selected from the group consisting of multinomial choice, logit, nested logit, generalized extreme value, probit, hybrid logit, and latent class.

20. The system of claim 17 wherein the predefined reliability criterion is unexpired.

21. A computer program product for conducting a search in response to a search request, the computer program product comprising at least one computer-readable storage medium having computer-readable program code portions stored therein, the computer-readable program code portions comprising:
a first executable portion capable of searching cached data and returning a plurality of options that satisfy the search request;
a second executable portion capable of determining which of the plurality of options that are returned are likely to be selected; and
a third executable portion capable of searching another database containing at least some data that is more current than the cached data to determine accuracy of at least one of the options that are likely to be selected.

22. The computer program product of claim 21 wherein determining which of the plurality of options are likely to be selected comprises analyzing the plurality of options with a discrete choice model of historic preferences from a plurality of searches.

23. The computer program product of claim 22 wherein the discrete choice model is selected from the group consisting of multinomial choice, logit, nested logit, generalized extreme value, probit, hybrid logit, and latent class.

24. The computer program product of claim 21 wherein searching another database comprises searching another database to determine accuracy of the one option most likely to be selected.

25. The computer program product of claim 21, wherein the cached data and data stored by the other database comprise availability data.

26. The computer program product of claim 25, wherein the availability data is chosen from the group comprising airline flight availability and hotel room availability.

27. A computer program product for conducting a search in response to a search request, the computer program product comprising at least one computer-readable storage medium having computer-readable program code portions stored therein, the computer-readable program code portions comprising:
a first executable portion capable of searching cached data and returning a plurality of options that satisfy the search request;
a second executable portion capable of determining which of the plurality of options that are returned are likely to be selected;
a third executable portion capable of determining if the cached data for at least one of the options that are likely to be selected is expired; and
a fourth executable portion capable of searching another database containing at least some data that is more recent than the cached data to determine accuracy of at least one of the options that are likely to be selected if the cached data meets a predefined reliability criterion.

28. The computer program product of claim 27 wherein determining which of the plurality of options are likely to be selected comprises analyzing the plurality of options with a discrete choice model of historic preferences from a plurality of searches.

29. The computer program product of claim 28 wherein the discrete choice model is selected from the group consisting of multinomial choice, logit, nested logit, generalized extreme value, probit, hybrid logit, and latent class.

30. The computer program product of claim 27 wherein the predefined reliability criterion is unexpired.
